(19) United States
(12) Patent Application Publication
(10) Pub. No.: US 2019/0279022 A1
(43) Pub. Date: Sep. 12, 2019

(54) OBJECT RECOGNITION METHOD AND DEVICE THEREOF

(71) Applicant: Chunghwa Picture Tubes, LTD., Taoyuan City (TW)

(72) Inventors: Chun-Chieh Chiu, Taoyuan City (TW); Hsiang-Tan Lin, Keelung City (TW); Pei-Lin Hsieh, Taoyuan City (TW)

(73) Assignee: Chunghwa Picture Tubes, LTD., Taoyuan City (TW)

(21) Appl. No.: 15/978,199

(22) Filed: May 14, 2018

(30) Foreign Application Priority Data
Mar. 8, 2018 (CN) 201810190398.8

(51) Int. Cl. G06K 9/46

(52) U.S. Cl. CPC G06K 9/4652; G06K 9/4642; G06K 9/4671

(57) ABSTRACT

An object recognition method and a device thereof are provided, the method includes: obtaining a plurality of key points of a test image and grayscale feature information of each of the key points, where the grayscale feature information is obtained according to a grayscale variation in the test image; obtaining hue feature information of each of the key points, where according to hue values of a plurality of adjacent pixels of the key point, the adjacent pixels are divided into a plurality of groups, and one of the groups is recorded as the hue feature information; and determining whether the test image is matched with a reference image according to the grayscale feature information and the hue feature information.

### CROSS-REFERENCE TO RELATED APPLICATION

This application claims the priority benefit of China application serial no. 201810190398.8, filed on Mar. 8, 2018. The entirety of the above-mentioned patent application is hereby incorporated by reference herein and made a part of this specification.

### BACKGROUND OF THE INVENTION

### Field of the Invention

The invention relates to an image recognition technology, and particularly relates to an object recognition method and a device thereof.

### Description of Related Art

In recent years, image recognition function is widely applied in various domains, such as visual recognition of a robot, gesture recognition and image tracking technique. Generally, during a process of image feature recognition, a commonly used technique is Scale-Invariant Feature Transform (SIFT) method. The SIFT method is a computer vision algorithm, which is used for detecting and describing local features of an image, by finding extreme points in a scale space, and extracting a position, a scale and rotation invariants thereof. The SIFT method has advantages of not being affected by scaling, geometric rotation and brightness changes, and is adapted to accurately identify objects with a same image feature. However, the general SIFT method cannot distinguish colors, so that when objects with the same features and different colors, for example, bottled beverages, are identified, a problem of recognition error is liable to be occurred. Moreover, when the general SIFT method performs key points comparison without considering a corresponding relationship between the related key points, it may also lead to recognition error in similar image features. Therefore, how to improve accuracy in object recognition is one of problems to be resolved.

### SUMMARY OF THE INVENTION

The invention is directed to an image recognition method and a device thereof, which are adapted to improve accuracy in object recognition.

An embodiment of the invention provides an object recognition method including following steps: obtaining a plurality of key points of a test image and grayscale feature information of each of the key points, where the grayscale feature information is obtained according to a grayscale variation in the test image; obtaining hue feature information of each of the key points, where according to hue values of a plurality of adjacent pixels of the key point, the adjacent pixels are divided into a plurality of groups, and one of the groups is recorded as the hue feature information; and determining whether the test image is matched with a reference image according to the grayscale feature information and the hue feature information.

In an embodiment of the invention, the object recognition method further includes: comparing the grayscale feature information of each of the key points of the test image with that of the reference image, and determining whether the grayscale feature information of the key point is matched according to a comparison result; when the comparison result is a match, further determining whether the hue feature information of the key point is matched, where when the hue feature information is matched, it is determined that the key point is matched, and when the when the comparison result is not the match or the hue feature information is not matched, it is determined that the key point is not matched; and when the number of matched key points is greater than a match value, determining that the test image is matched with the reference image, conversely, determining that the test image is not matched with the reference image.

In an embodiment of the invention, the object recognition method further includes: recording a plurality of adjacent key points of each of the key points, where a space around each of the key points is divided into a plurality of quadrants, and recording another key point that is closest to the key point in each of the quadrants as one of the adjacent key points; and when the comparison result of one of the key points is the match and the hue feature information are all matched, further determining whether at least one of the adjacent key points of the key point is matched, where when the at least one of the adjacent key points is matched, it is determined that the key point is matched, conversely, it is determined that the key point is not matched.

In an embodiment of the invention, the object recognition method further includes: recording the group with the maximum adjacent pixel number as the hue feature information, or calculating an average hue value of a plurality of the adjacent pixels, and recording the group corresponding to the average hue value as the hue feature information.

An embodiment of the invention provides an object recognition device including a storage device and a computing device. The storage device stores a plurality of reference images and a plurality of instructions. The computing device is coupled to the storage device, and receives a test image, and is configured to execute a plurality of instructions to: obtain a plurality of key points of the test image and grayscale feature information of each of the key points, where the grayscale feature information is obtained according to a grayscale variation in the test image; obtain hue feature information of each of the key points, where according to hue values of a plurality of adjacent pixels of the key point, the adjacent pixels are divided into a plurality of groups, and one of the groups is recorded as the hue feature information; and determine whether the test image is matched with one of the reference images according to the grayscale feature information and the hue feature information.

Another embodiment of the invention provides an object recognition method including: obtaining a plurality of key points of a test image and feature information of each of the key points; recording a plurality of adjacent key points of each of the key points, where a space around each of the key points is divided into a plurality of quadrants, and recording another key point that is closest to the key point in each of the quadrants as one of the adjacent key points; and determining whether the test image is matched with a reference image according to the feature information and the adjacent key points.

In an embodiment of the invention, the object recognition method includes: comparing the feature information of each of the key points of the test image with that of the reference image, and determining whether the feature information of the key point is matched according to a comparison result; when the comparison result is a match, further determining whether at least one of the adjacent key points of the key point is matched, where when the at least one of the adjacent key points of the key point is matched, it is determined that the key point is matched, conversely or when the comparison result is not the match, it is determined that the key point is not matched; and when the number of the matched key points is greater than a match value, determining that the test image is matched with the reference image, conversely, determining that the test image is not matched with the reference image.

In an embodiment of the invention, the feature information includes grayscale feature information and hue feature information, where the grayscale feature information is obtained according to a grayscale variation in the test image, and according to hue values of a plurality of adjacent pixels of the key point, the adjacent pixels are divided into a plurality of groups, and one of the groups is recorded as the hue feature information; comparing the grayscale feature information and the adjacent key points of each of the key points of the test image with that of the reference image so as to determine whether the grayscale feature information and the at least one of the adjacent key points are both matched, and generating a comparison result; when the comparison result is both the match, further determining whether the hue feature information of the key point is matched, where when the hue feature information is matched, it is determined that the key point is matched, and when the comparison result is not all the match or the hue feature information is not matched, it is determined that the key point is not matched; and when the number of matched key points is greater than a match value, determining that the test image is matched with the reference image, conversely, determining that the test image is not matched with the reference image.

An embodiment of the invention provides an object recognition device including a storage device and a computing device. The storage device stores a plurality of reference images and a plurality of instructions. The computing device is coupled to the storage device, and receives a test image, and is configured to execute a plurality of instructions to: record a plurality of adjacent key points of each of the key points, where a space around each of the key points is divided into a plurality of quadrants, and record another key point that is closest to the key point in each of the quadrants as one of the adjacent key points; and determine whether the test image is matched with one of the reference images according to the feature information and the adjacent key points.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an object recognition device according to an embodiment of the invention.

FIG. 2 is a flowchart illustrating an object recognition method according to an embodiment of the invention.

FIG. 3 is a schematic diagram of an implementation of finding key points through a Scale-Invariant Feature Transform (SIFT) method according to an embodiment of the invention.

FIG. 4 is a schematic diagram of an implementation of obtaining grayscale feature information of the key points through the SIFT method according to an embodiment of the invention.

FIG. 5 is a schematic diagram of an implementation of calculating hue feature information of the key points through the SIFT method according to an embodiment of the invention.

FIG. 6 is a flowchart illustrating an object recognition method according to another embodiment of the invention.

FIG. 7 is a schematic diagram of space quadrants according to another embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

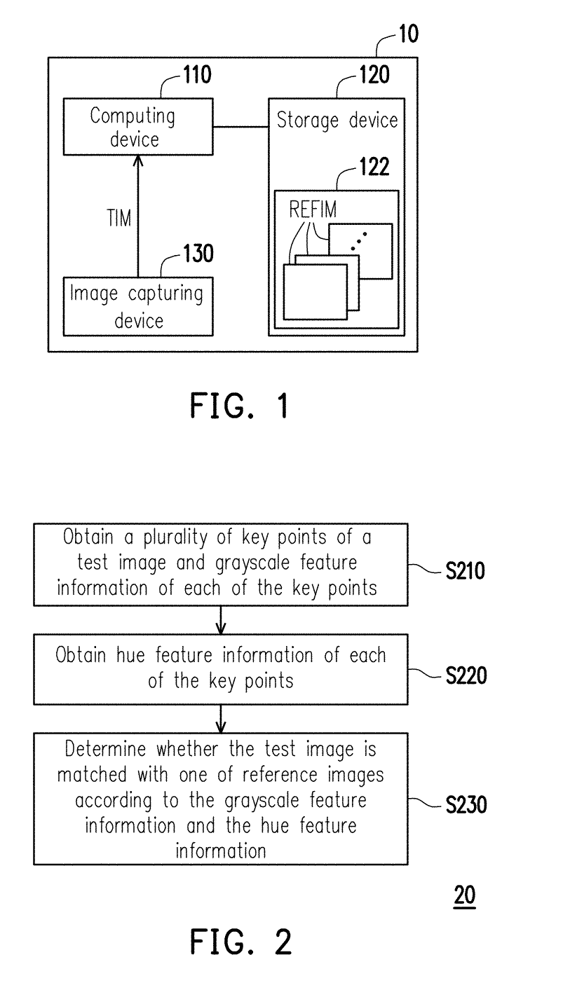

FIG. 1 is a functional block diagram of an object recognition device according to an embodiment of the invention. Referring to FIG. 1, the object recognition device 10 includes a computing device 110, a storage device 120 and an image capturing device 130.

The computing device 110 is coupled to the storage device 120 and the image capturing device 130. The computing device 110 is, for example, a general purpose processor, a special purpose processor, a conventional processor, a digital signal processor (DSP), a microprocessor, one or a plurality of microprocessors combined with a digital signal processor core, a controller, a micro controller, an Application Specific Integrated Circuit (ASIC), a Field Programmable Gate Array (FPGA), any other type of integrated circuit, a state machine, a processor based on advanced RISC machine (ARM) and a similar device.

The storage device 120 is, for example, any type of a stationary or mobile Random Access Memory (RAM), a Read-Only Memory (ROM), a flash memory, a hard disk or other similar devices or a combination of these devices. In the present embodiment, the storage device 120 includes a reference image database 122, the reference image database 122 stores a plurality of reference images REFIM, and the storage device 120 further stores a plurality of instructions adapted to be executed by the computing device 110. Therefore, the computing device 110 may execute the instructions in the storage device 120 to execute a plurality of steps, so as to implement functions of internal hardware assemblies of the object recognition device 10.

The image capturing device 130 is used for capturing an image and providing a test image TIM to the computing device 110. The image capturing device 130 is, for example, any video camera having a Charge Coupled Device (CCD), a Complementary Metal Oxide Semiconductor (CMOS) or an infrared lens, or may be an image capturing device capable of obtaining depth information, for example, a depth camera or a three-dimensional (3D) video camera, though the invention is not limited thereto.

It should be noted that the image capturing device 130 is not necessary, and in other embodiments, the object recognition device 10 may not include the image capturing device 130, and the computing device 110 may receive the test image TIM through an input/output interface (not shown) or from the storage device 120.

FIG. 2 is a flowchart illustrating an object recognition method according to an embodiment of the invention. The object recognition method 20 of the present embodiment may be executed by the object recognition device 10 of FIG. 1, and detailed steps of the method are described below with reference of various components of FIG. 1.

In step S210, the computing device 110 obtains a plurality of key points of the test image TIM and grayscale feature information of each of the key points, where the grayscale feature information is obtained according to a grayscale variation in the test image TIM. The computing device 110 may use a Scale-Invariant Feature Transform (SIFT) method or a Speeded-Up Robust Features (SURF) method, etc., which is not limited by the invention, to find the required key points and the grayscale feature information of each of the key points.

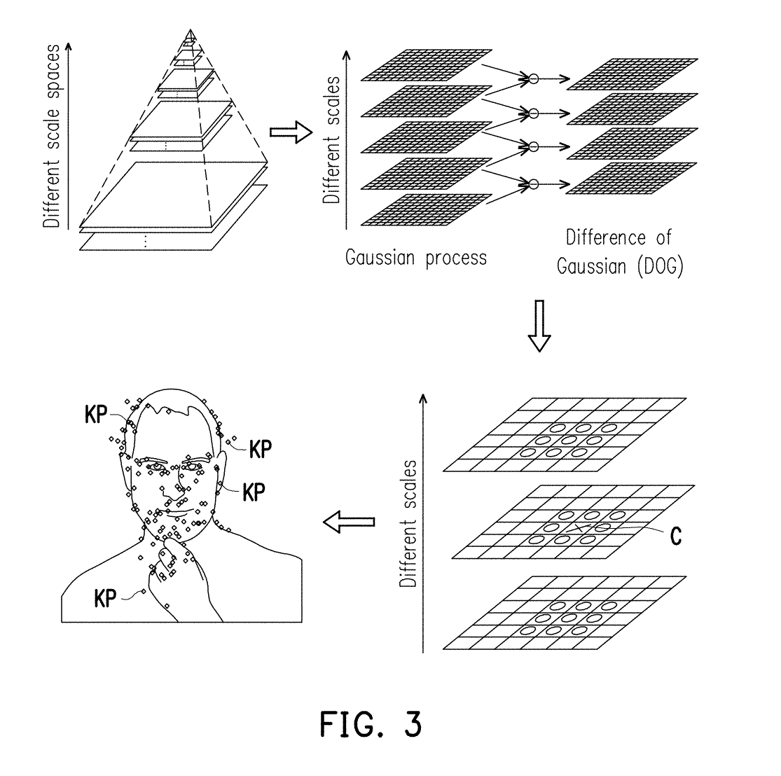

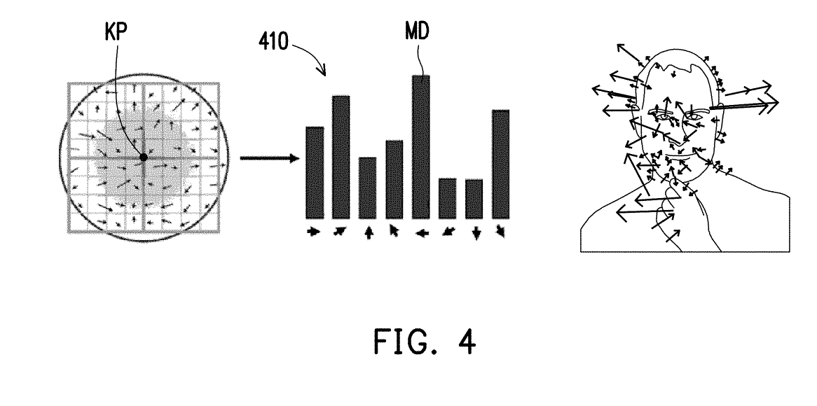

FIG. 3 is a schematic diagram of an implementation of finding the key points through the SIFT method according to an embodiment of the invention. FIG. 4 is a schematic diagram of an implementation of obtaining the grayscale feature information of the key points through the SIFT method according to an embodiment of the invention. Referring to FIG. 3 and FIG. 4, in the present embodiment, the computing device 110 uses the SIFT method to detect and scan local features of the test image TIM, for example, to find extreme points in a scale space to serve as the key points. To be specific, the computing device 110 performs Gaussian process using different scales on the test image TIM at different magnifications, i.e. to use different Gaussian filters to perform convolution to form a Gaussian pyramid, and then a subtraction between each next images in the Gaussian pyramid is made to form a Difference Of Gaussian (DOG), and then each pixel in a DOG image, for example, a center pixel C of FIG. 3 is compared with adjacent pixels surrounding itself and adjacent pixels belongs to the near scale but at the same position in a same group of DOG images, so as to find the pixels with extreme values to serve as the key points KP.

The computing device 110 may further calculate a grayscale gradient variation of each patch in the test image TIM where each of the key points is located, and classify grayscales to determine a main direction of rotation to obtain grayscale feature information of the key points of the block. For example, in the embodiment of FIG. 4, first, for the key point KP, a histogram 410 of 8 directions is established for each sub-region with 4*4 pixels, and in the regions around the key point KP, for example, total 16 sub-regions, a magnitude and direction of a gradient value of each pixel are calculated and added to the histogram 410 to locate a main direction MD, so that the grayscale feature information of the key point KP has 128 feature values related to the grayscale gradient value. How to calculate the key points and the grayscale feature information or the number of the feature values is not limited by the invention. Moreover, those skilled in the art may learn enough instructions and recommendations from common knowledge of the field for detailed implementation of calculating the key points of the test image and the corresponding grayscale feature information, and details thereof are not repeated.

In step S220, the computing device 110 obtains hue feature information of each of the key points. To be specific, the computing device 110 may calculate hue values of the adjacent pixels around each of the key points. The computing device 110 may divide the adjacent pixels into a plurality of groups according to the hue values of the adjacent pixels of the key point, and record one of the groups as the hue feature information, where the group with the maximum adjacent pixel number may be selected as the hue feature information or the group corresponding to an average hue value of the adjacent pixels is set as the hue feature information.

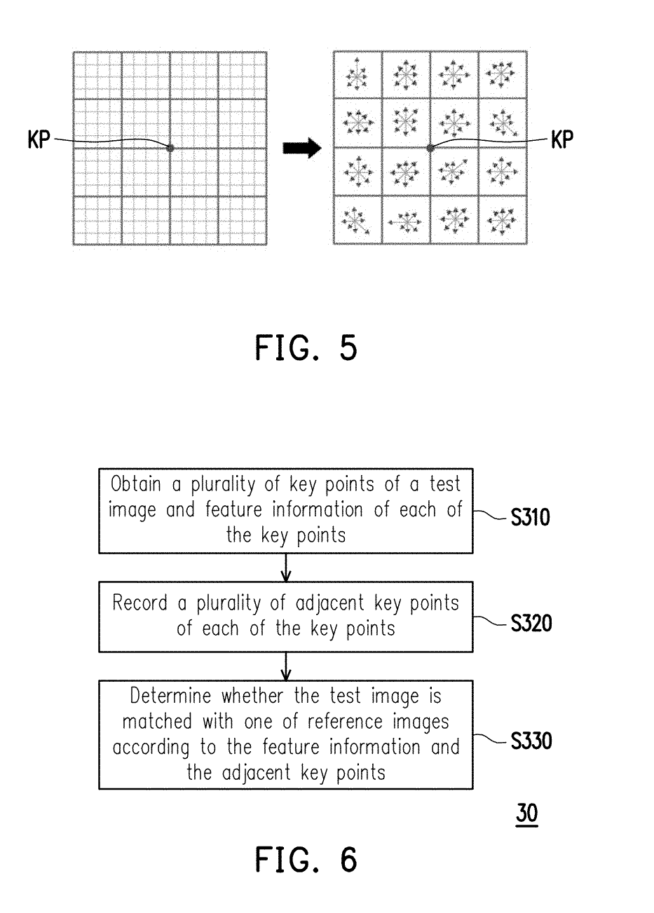

FIG. 5 is a schematic diagram of an implementation of calculating the hue feature information of the key points through the SIFT method according to an embodiment of the invention. In the embodiment of FIG. 5, according to the hue values, the adjacent pixels of the key point KP are divided into 8 groups, for example, 0-45 degrees is a group A, 46-90 degrees is a group B, 91-135 degrees is a group C, etc., and the others are deduced by analogy. In an embodiment, when the computing device 110 calculates the hue value for the each of the key points, the number of the adopted adjacent pixels is equal to the number of the pixels used for calculating the feature values, for example, in the embodiments of FIG. 4 and FIG. 5, when the grayscale feature information and the hue feature information are calculated, the same 16 sub-regions are used, and the number of the adopted adjacent pixels is the same.

In the present embodiment, the computing device 110 further determine the group with the hue values of the maximum adjacent pixel number and takes a referential number thereof as the hue feature information. Taking the group A where the hue values of the maximum adjacent pixel number fall within a range of 0-45 degrees as an example, the hue feature information of the key point is recorded as the group A, and is stored in the storage device 120, so that the feature information of the key point includes the grayscale feature information with 128 feature values and the hue feature information with one feature value.

In another embodiment, the computing device 110 may take a referential number of the group corresponding to the average hue value of the adjacent pixels as the hue feature information. The computing device 110 further calculates the average hue value, taking the group A where the average hue value of the adjacent pixels fall within the range of 0-45 degrees as an example, the hue feature information of the key point is recorded as the group A, and is stored in the storage device 120, so that the feature information of the key point also includes the grayscale feature information with 128 feature values and the hue feature information with one feature value.

In step S230, the computing device 110 determines whether the test image TIM is matched with one of the reference images REFIM stored in the storage device 120 according to the grayscale feature information and the hue feature information.

In detail, after the computing device 110 receives the test image TIM and obtains the key points and the feature information (for example, the grayscale feature information and the hue feature information), the computing device 110 may compare the grayscale feature information of each key point of the test image TIM with that of the reference image REFIM in the reference image database 122 to generate a comparison result, and determine whether the grayscale feature information of the test image TIM is matched with that of the compared reference image REFIM according to the comparison result.

The computing device 110 may determine whether the comparison result is a match according to whether a difference between the grayscale feature information of the test image TIM and the reference image REFIM is not greater than a threshold value, and the threshold value may be adjusted according to an image feature of the image, for example, the threshold value is set according to a type of the test image TIM, such as a landscape type image, a portrait type image, a still life type image, etc., or the threshold value may be a predetermined fixed value, or may be adjusted according to user's requirement, which is not limited by the invention.

In an embodiment, the computing device 110 may adopt an Euclidean distance calculation method (though the invention is not limited thereto) to determine which one of the reference images REFIM in the reference image database 122 has the key point closest to the grayscale feature information of the test image TIM. For example, when a least square error between the grayscale feature information of the key points of the two images is not greater than a threshold value, the comparison result is determined as a match, and when the least square error is greater than the threshold value, the comparison result is determined as a mismatch.

When the comparison result is a match, the computing device 110 may further determine whether the hue feature information of the key point with the matched grayscale feature information is matched. For example, the comparison result of the grayscale feature information of a certain key point of the reference image REFIM and the test image TIM is a match, the hue feature information of the key point is further compared, and if both of the hue feature information belong to the group A, it represents that the hue feature information is matched, and if one belongs to the group A and another one belongs to the group C, it represents that the colors of the key points are different, and the hue feature information is not match. Therefore, when the hue feature information is matched, the computing device 110 determines that the key point is matched, and when the comparison result is not the match or the hue feature information is not matched, the computing device 110 determines that the key point is not matched.

The more the key points are determined to be matched, the higher a match degree between the test image TIM and the reference image REFIM is, and when the number of the matched key points is greater than a match value, the computing device 110 determines that the test image TIM and the reference image REFIM is matched, conversely, determines that the test image TIM and the reference image REFIM is not matched. A user may determine the match value according to an actual application, so that in an embodiment, when only a part of the key points is determined to be matched, the image may be determined to be matched, and in another embodiment, it may be requested that only when all of the key points are determined to be matched, the image is determined to be matched, which is not limited by the invention. Therefore, in the present embodiment, the object recognition device 10 and the object recognition method have the effect of further identifying whether the key points have the same color.

FIG. 6 is a flowchart illustrating an object recognition method according to another embodiment of the invention. The object recognition method 30 of the present embodiment may be executed by the object recognition device 10 of FIG. 1, and detailed steps of the method are described below with reference of the embodiments of FIG. 1 to FIG. 4.

In step S310, the computing device 110 obtains a plurality of key points of the test image TIM and feature information of each of the key points, where the feature information is, for example, the grayscale feature information of the aforementioned embodiment, and how to obtain the key points and the grayscale feature information is not repeated.

In step S320, the computing device 110 records a plurality of adjacent key points of each of the key points. During the process that the computing device 110 obtains the feature information of each of the key points, the computing device 110 may take the key point as a center to divide a space around the key point into a plurality of quadrants, and record another key point that is closest to the key point in each of the quadrants as one of the adjacent key point.

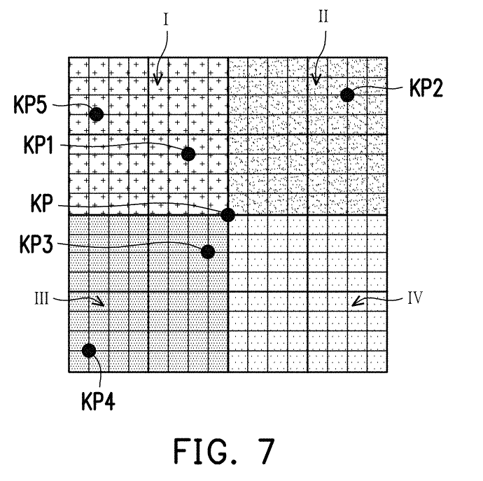

FIG. 7 is a schematic diagram of space quadrants according to another embodiment of the invention. In the embodiment of FIG. 7, the key point KP is taken as a center to divide the surrounding space into 4 quadrants: a first quadrant I, a second quadrant II, a third quadrant III and a fourth quadrant IV, and the number of the quadrants is not limited by the invention. The computing device 110 may find another key point that is closest to the key point KP in each of the quadrants, and record it as an adjacent key point. For example, the first quadrant I has other key points KP1 and KP5, the second quadrant II has a key point KP2, the third quadrant III has key points KP3 and KP4, and the fourth quadrant IV have no key point, so that the computing device 110 selects the key point KP1 that is the closest to the key point KP in the first quadrant I as the adjacent key point, and selects the key point KP2 in the second quadrant II and the closest key point KP3 in the third quadrant III, and selects no key point of the fourth quadrant IV, and the computing device 110 records the referential numbers of the aforementioned selected adjacent key points to serve as adjacent feature information of the key point KP. In the case that the fourth quadrant IV have no key point, the referential number of the adjacent key point corresponding to the fourth quadrant IV may be set to a default value, for example, 0.

In step S330, the computing device 110 determines whether the test image TIM is matched with one of the reference images REFIM stored in the storage device 120 according to the feature information and the adjacent key points.

The computing device 110 may compare the feature information of each of the key points of the test image TIM with that of the reference image REFIM, and determine whether the feature information of the key point is matched according to a comparison result. The feature information is, for example, the grayscale feature information, and the method of determining the comparison result has been described in the aforementioned embodiment, so that detail thereof is not repeated.

When the comparison result is a match, the computing device 110 further determines whether at least one of the adjacent key points of the key point is matched, where when the at least one of the adjacent key points is matched, it is determined that the key point is matched, conversely or when the comparison result is not the match, it is determined that the key point is not matched. For example, the computing device 110 may first compare the 128 feature values of the grayscale feature information of the key point KP, and when the comparison result is a match, the computing device 110 further compares the 4 adjacent key points (there are four quadrants in the embodiment of FIG. 7) of the key point KP, and if one of the adjacent key points (for example, the key point KP1 of the first quadrant I) is determined to be matched, the computing device 110 determines that the key point KP is matched, conversely, determines that the key point KP is not matched.

To be specific, since the adjacent feature information records the referential numbers of the adjacent key points, the computing device 110 may find the feature information (for example, the grayscale feature information) of each of the adjacent key points from the storage device 120 according to the referential numbers, and the computing device 110 may compare the grayscale feature information of the adjacent key points to determine whether the adjacent key points are matched. The description of the aforementioned embodiment may be referred for a detailed implementation of determining whether the adjacent key points are matched through the grayscale feature information, which is not repeated. Since the adjacent feature information of the present embodiment only record the referential numbers of the adjacent key points, it is unnecessary to repeatedly record the grayscale information of the adjacent key points, and it is able to further compare the adjacent key points without increasing an extra memory burden.

In another embodiment, the computing device 110 may determine that the key point KP is matched only when at least two of the adjacent points (at least a half of the adjacent key points) are matched, and in another embodiment, the computing device 110 may determine that the key point KP is matched only when at least three of the adjacent points, or even all of the adjacent key points are matched, which is not limited by the invention.

Similarly, when it is determined that the number of the matched key points is greater than the match value, the computing device 110 may determine that the test image TIM is matched with the reference image REFIM, conversely, the computing device 110 determines that the two images are not matched. Therefore, the object recognition device 10 of the present embodiment and the object recognition method 30 may consider the corresponding relationship of the corresponding key points, so as to improve recognition correctness.

In another embodiment, besides the grayscale feature information, the feature information further includes the hue feature information, so that the computing device 110 may first compare the grayscale feature information and the hue feature information, and after the grayscale feature information is determined to be matched and the hue feature information is determined to be matched, the computing device 110 further compares the adjacent key points to determine whether the key point is matched.

In another embodiment, besides the grayscale feature information, the feature information further includes the hue feature information, and a difference with the aforementioned embodiment is that the computing device 110 may first compare the grayscale feature information and the adjacent key points, and after the grayscale information of the key point is determined to be matched and at least one of the adjacent key points is determined to be matched, the hue feature information is compared. A comparison sequence of the invention is not limited, and those skilled in the art may adjust it according to an actual requirement.

In summary, in the object recognition method and the device thereof, besides that a plurality of the key points of the test image are obtained and the grayscale feature information of each of the key points is obtained according to the grayscale variation in the test image, the hue feature information is further obtained according to the adjacent pixels of each of the key points, where the hue feature information records the main hue value of the adjacent pixels or the type of the average hue value, so that the object recognition method and the object recognition device of the invention may identify an object color. Moreover, since it is only required to record and compare the type of the hue values, a computation capacity is low and requirement on memory capacity is also low, such that a recognition speed is fast and a computation burden is low, and an efficient and high accurate recognition function is provided. In the object recognition method and the device thereof in another embodiment of the invention, besides that a plurality of the key points of the test image and the feature information are obtained, the adjacent key points of each of the key points are further recorded corresponding to each spatial quadrant. Moreover, since only the referential numbers of the adjacent key points are recorded, requirement on memory capacity is also low, and the object recognition method and the device thereof may further consider the corresponding relationship of the key points, so as to improve the recognition efficiency and accuracy.

In an embodiment of the invention, the object recognition method further includes setting a threshold value according to the type of the test image, and determining whether the comparison result is a match according to whether grayscale feature information difference between the test image and the reference image is not greater than the threshold value.

In an embodiment of the invention, the object recognition device further includes an image capturing device coupled to the computing device, and the image capturing device is used for providing the test image.

In the object recognition method of another embodiment of the invention, the object recognition method includes: comparing the feature information of each of the key points of the test image with that of the reference image, and determining whether the feature information of the key point is matched according to the comparison result; when the comparison result is a match, further determining whether at least a half of a plurality of the adjacent key points of the key point is matched, where when at least a half of the adjacent key points is matched, it is determined that the key point is matched, conversely or when the comparison result is not the match, it is determined that the key point is not matched; and when the number of the matched key points is greater than the match value, determining that the test image and the reference image are matched, conversely, determining that the test image and the reference image are not matched.

In the object recognition method of another embodiment of the invention, the object recognition method includes: comparing the feature information of each of the key points of the test image with that of the reference image, and determining whether the feature information of the key point is matched according to the comparison result; when the comparison result is a match, further determining whether all of a plurality of the adjacent key points of the key point are matched, where when all of the adjacent key points are matched, it is determined that the key point is matched, and when the at least one of the adjacent key points is not matched or when the comparison result is not the match, it is determined that the key point is not matched; and when the number of the matched key points is greater than the match value, determining that the test image and the reference image are matched, conversely, determining that the test image and the reference image are not matched.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An object recognition method, comprising:
obtaining a plurality of key points of a test image and grayscale feature information of each of the key points, wherein the grayscale feature information is obtained according to a grayscale variation in the test image;
obtaining hue feature information of each of the key points, wherein according to hue values of a plurality of adjacent pixels of the key point, the adjacent pixels are divided into a plurality of groups, and one of the groups is recorded as the hue feature information; and
determining whether the test image is matched with a reference image according to the grayscale feature information and the hue feature information.

2. The object recognition method as claimed in claim 1, wherein the step of determining whether the test image is matched with the reference image comprises:
comparing the grayscale feature information of each of the key points of the test image with that of the reference image, and determining whether the grayscale feature information of the key point is matched according to a comparison result;
when the comparison result is a match, further determining whether the hue feature information of the key point is matched, wherein when the hue feature information is matched, it is determined that the key point is matched, and when the comparison result is not the match or the hue feature information is not matched, it is determined that the key point is not matched; and
when the number of matched key points is greater than a match value, determining that the test image is matched with the reference image, conversely, determining that the test image is not matched with the reference image.

3. The object recognition method as claimed in claim 2, wherein the step of determining whether the test image is matched with the reference image further comprises:
recording a plurality of adjacent key points of each of the key points, wherein a space around each of the key points is divided into a plurality of quadrants, and recording another key point that is closest to the key point in each of the quadrants as one of the adjacent key points; and
when the comparison result of one of the key points is the match and the hue feature information is matched, further determining whether at least one of the adjacent key points of the key point is matched, wherein when the at least one of the adjacent key points is matched, it is determined that the key point is matched, conversely, it is determined that the key point is not matched.

4. The object recognition method as claimed in claim 1, wherein the step of recording one of the groups as the hue feature information comprises:
recording the group with the maximum adjacent pixel number as the hue feature information, or calculating an average hue value of the adjacent pixels, and recording the group corresponding to the average hue value as the hue feature information.

5. An object recognition device, comprising:
a storage device, storing a plurality of reference images and a plurality of instructions; and
a computing device, coupled to the storage device, receiving a test image, and configured to execute the instructions to:
obtain a plurality of key points of the test image and grayscale feature information of each of the key points, wherein the grayscale feature information is obtained according to a grayscale variation in the test image;
obtain hue feature information of each of the key points, wherein according to hue values of a plurality of adjacent pixels of the key point, the adjacent pixels are divided into a plurality of groups, and one of the groups is recorded as the hue feature information; and
determine whether the test image is matched with one of the reference images according to the grayscale feature information and the hue feature information.

6. The object recognition device as claimed in claim 5, wherein
the computing device compares the grayscale feature information of each of the key points of the test image with that of the reference image, and determines whether the grayscale feature information of the key point is matched according to a comparison result;
when the comparison result is a match, the computing device further determines whether the hue feature information of the key point is matched, wherein when the hue feature information is matched, the computing device determines that the key point is matched, and when the comparison result is not the match or the hue feature information is not matched, the computing device determines that the key point is not matched; and
when the number of matched key points is greater than a match value, the computing device determines that the test image is matched with the reference image, conversely, the computing device determines that the test image is not matched with the reference image.

7. The object recognition device as claimed in claim 6, wherein
the computing device records a plurality of adjacent key points of each of the key points of the test image in the storage device, wherein a space around each of the key points is divided into a plurality of quadrants, and the computing device records another key point that is closest to the key point in each of the quadrants as one of the adjacent key points; and
when the comparison result of the test image and the reference image is the match and the hue feature information is matched, the computing device further determines whether at least one of the adjacent key points of the key point is matched, wherein when the at least one of the adjacent key points is matched, the computing device determines that the key point is matched, conversely, the computing device determines that the key point is not matched.

8. An object recognition method, comprising:
obtaining a plurality of key points of a test image and feature information of each of the key points;
recording a plurality of adjacent key points of each of the key points, wherein a space around each of the key points is divided into a plurality of quadrants, and recording another key point that is closest to the key point in each of the quadrants as one of the adjacent key points; and
determining whether the test image is matched with a reference image according to the feature information and the adjacent key points.

9. The object recognition method as claimed in claim 8, wherein the step of determining whether the test image is matched with the reference image comprises:
comparing the feature information of each of the key points of the test image with that of the reference image, and determining whether the feature information of the key point is matched according to a comparison result;
when the comparison result is a match, further determining whether at least one of the adjacent key points of the key point is matched, wherein when the at least one of the adjacent key points is matched, it is determined that the key point is matched, conversely or when the comparison result is not the match, it is determined that the key point is not matched; and
when the number of the matched key points is greater than a match value, determining that the test image is matched with the reference image, conversely, determining that the test image is not matched with the reference image.

10. The object recognition method as claimed in claim 8, wherein the step of determining whether the test image is matched with the reference image comprises:
the feature information comprising grayscale feature information and hue feature information, wherein the grayscale feature information is obtained according to a grayscale variation in the test image, and according to hue values of a plurality of adjacent pixels of the key point, the adjacent pixels are divided into a plurality of groups, and one of the groups is recorded as the hue feature information;
comparing the grayscale feature information and the adjacent key points of each of the key points of the test image with that of the reference image so as to determine whether the grayscale feature information and the at least one of the adjacent key points are both matched, and generating a comparison result;
when the comparison result is both a match, further determining whether the hue feature information of the key point is matched, wherein when the hue feature information is matched, it is determined that the key point is matched, and when the comparison result is not both the match or the hue feature information is not matched, it is determined that the key point is not matched; and
when the number of matched key points is greater than a match value, determining that the test image is matched with the reference image, conversely, determining that the test image is not matched with the reference image.

11. An object recognition device, comprising:
a storage device, storing a plurality of reference images and a plurality of instructions; and
a computing device, coupled to the storage device, receiving a test image, and configured to execute the instructions to:
obtain a plurality of key points of the test image and feature information of each of the key points;
record a plurality of adjacent key points of each of the key points, wherein a space around each of the key points is divided into a plurality of quadrants, and record another key point that is closest to the key point in each of the quadrants as one of the adjacent key points; and
determine whether the test image is matched with one of the reference images according to the feature information and the adjacent key points.

12. The object recognition device as claimed in claim 11, wherein
the computing device compares the feature information of each of the key points of the test image with that of the reference image, and determines whether the feature information of the key point is matched according to a comparison result;
when the comparison result is a match, the computing device further determines whether at least one of the adjacent key points of the key point is matched, wherein when the at least one of the adjacent key points of the key point is matched, the computing device determines that the key point is matched, conversely or when the comparison result is not the match, the computing device determines that the key point is not matched; and
when the number of the matched key points is greater than a match value, the computing device determines that the test image is matched with the reference image, conversely, the computing device determines that the test image is not matched with the reference image.

13. The object recognition device as claimed in claim 11, wherein the feature information comprises grayscale feature information or the grayscale feature information and hue feature information, wherein the grayscale feature information is obtained according to a grayscale variation in the test image, and according to hue values of a plurality of adjacent pixels of the key point, the adjacent pixels are divided into a plurality of groups, and one of the groups is recorded as the hue feature information;
the computing device compares the grayscale feature information and the adjacent key points of each of the key points of the test image with that of the reference image so as to determine whether the grayscale feature information and the at least one of the adjacent key points are both matched, and generates a comparison result;
when the comparison result is both a match, the computing device further determines whether the hue feature information of the key point is matched, wherein when the hue feature information is matched, the computing device determines that the key point is matched, and when the comparison result is not both the match or the hue feature information is not matched, the computing device determines that the key point is not matched; and
when the number of matched key points is greater than a match value, the computing device determines that the test image is matched with the reference image, conversely, the computing device determines that the test image is not matched with the reference image.
